(19) United States
(12) Patent Application Publication
(10) Pub. No.: US 2024/0009960 A1
(43) Pub. Date: Jan. 11, 2024

(54) Waterproof Breathable Textile

(71) Applicant: Amphibio LTD, London (GB)

(72) Inventor: Jun Kamei, London (GB)

(21) Appl. No.: 18/253,109

(22) PCT Filed: Nov. 16, 2021
(86) PCT No.: PCT/GB2021/052966

§ 371 Date: May 16, 2023

(30) Foreign Application Priority Data
Nov. 16, 2020 (GB) 2018018.8

(51) Int. Cl. B32B 5/26; D06C 7/00; D01D 5/08; D01D 7/00; D01D 5/253; D01F 6/30; D04H 1/4291; D04H 1/4382; D04H 1/56; D04H 1/728; B32B 27/32; B32B 27/18; B32B 5/02

(52) U.S. Cl. CPC B32B 5/279; D06C 7/00; D01D 5/08; D01D 7/00; D01D 5/253; D01F 6/30; D04H 1/4291; D04H 1/43838; D04H 1/56; D04H 1/728; B32B 27/32; B32B 27/18; B32B 5/026; B32B 5/024; B32B 5/022; B32B 5/275; D10B 2321/02; D10B 2401/063; D10B 2401/10; D10B 2501/04; B32B 2307/54; B32B 2437/00; B32B 2250/20; B32B 2307/724; B32B 2307/7265

(57) ABSTRACT

A waterproof breathable textile (200) comprises a substrate (202) and a gas-permeable, water-impermeable porous membrane (204) disposed on the substrate. The substrate and the porous membrane are made from or comprise the same material, or of the same type of material e.g. polymers. A method of manufacturing a waterproof breathable textile (200) is also provided. The method comprises disposing a gas-permeable, water-impermeable porous membrane (204) on a substrate (202). The substrate and the porous membrane are made from or comprise the same material, or of the same type of material e.g. polymers.

The present invention relates to a waterproof breathable textile, and a method of manufacturing a waterproof breathable textile.

### BACKGROUND

A waterproof breathable textile (WBT) is a textile that is gas permeable and water impermeable. The term “breathable” refers to the fact that gas (e.g., air, water vapour) is able to permeate through the textile. WBTs typically comprise a gas-permeable, water-impermeable membrane laminated to one or more layers of material (e.g., fabric or textile). A water-repellent coating may be applied to an outer layer of material to prevent it from becoming soaked.

Membranes for WBTs fall into two general categories—porous and non-porous. Porous membranes employ micron-sized to sub-micron-sized pores to prevent the passage of liquid (e.g., raindrops) through the membrane whilst allowing small gaseous molecules (e.g., water vapour molecules) to permeate through the membrane. The material of the porous membrane will also have an intrinsic permeability for respective gaseous molecules, which may allow gaseous molecules to also pass through the membrane material itself in addition to the pores in the membrane. However, the primary transport mechanism for gaseous molecules through a porous membrane is typically through the pores in the membrane. In contrast, in non-porous membranes the primary transport mechanism for gaseous molecules is permeation through the membrane material itself, for example by transporting water vapour molecules along hydrophilic polymer chains in the membrane.

WBTs are used heavily in the outdoor industry with 300 to 500 million square metres of WBTs being produced annually. WBTs can be used to manufacture a variety of products, such as waterproof garments, shoes, tents and bags. In 2016 the WBT market was worth approximately £2.1 billion.

WBTs are often used in rainwear garments, such as raincoats, in order to keep the person wearing the garment dry, whilst allowing moist air containing evaporated sweat to be expelled from the garment, for example creating added comfort.

However, conventional WBTs suffer from a number of drawbacks, particularly with respect to the environmental impact.

The present invention has been devised with the foregoing in mind.

### SUMMARY OF INVENTION

According to a first aspect, there is provided a textile. The textile may be a waterproof breathable textile. The textile may comprise a substrate. The textile may also comprise a porous membrane disposed on the substrate. The porous membrane may be a gas-permeable, water-impermeable porous membrane. The substrate and the porous membrane may be made from or comprise or consist of the same material or the same type of material. The type of material may be a category of materials, e,g. a category of polymers. The substrate and the porous membrane may be made from or comprise or consist of a material comprising one or more polymers from within the same polymer category.

Reference throughout to “material” also refers to material of the same type.

A category of materials may refer to a group of materials that are all recyclable. The category may refer to a group of materials that can be recycled together, e.g. as a blend. Having the substrate and porous membrane being formed from, comprising, or consisting of materials which can be recycled together enables the entire textile to be recycled as a single unit, without having to separate the textile into constituent parts. This provides the advantage of making the textile easier to recycle.

The polymer category may be polyolefins. Example polymers from within this category may be polypropylene, polyethylene, polyolefin elastomers, polymethylpentene, or polymethylpentene copolymerised with one or more of polymethylpentane, polymethylhexane, polymethylheptanem polymethyloctane, one or more α-olefins, or one or more α-polyolefins or other olefins.

The polymer category may be polyester. Example polymers from within this category may be polyethylene terephthalate or polybutylene succinate.

The polymer category may be polyamide. Example polymers from within this category may be Nylon 6, or Nylon 66.

In conventional waterproof breathable textiles (WBTs), particularly WBTs having porous membranes, the membrane and the substrate are typically made from or comprise different materials. The membrane and the substrate are often made from or comprise materials which are not the same type of material (e.g., they are formed from or comprise different types or polymer). The multi-layer and multi-material nature of conventional WBTs means that conventional WBTs are often difficult to recycle. When a garment or other product made from or comprising a conventional WBT is no longer usable, the materials of the WBT are difficult to recover, separate from one another and reuse in order to manufacture new WBTs. That typically results in the WBT being incinerated or sent to landfill. In turn, that means that new materials must be extracted, synthesised or produced in order to manufacture new WBTs. That incurs further expense and time in producing new WBTs. Some WBTs employ non-porous membranes and use similar or the same materials for the membrane as for the substrate. However, the lack of physical pores in non-porous membrane WBTs often adversely affects performance parameters such as breathability, particularly in heavy rain and/or high humidity conditions due to swelling and saturation of the membrane. Porous membranes typically offer better performance.

An advantage of the present invention is that the textile is formed from a single material or a single type of material. Each component or layer of the textile is formed from the same material or the same type of material. That may allow the material(s) to be easily recyclable. No separation of layers may be required in order to recover the materials from the WBT. Rather, the textile may be recycled as a single, unitary, mono-material product or type of products. That may decrease the environmental impact of the textile by increasing ease and speed, and decreasing cost, of recycling the textile. In addition, the porous membrane of the present invention may enable those advantages whilst retaining the superior performance of a porous membrane.

Having the membrane and the substrate formed from the same material or same type of material also provides the advantage of increasing bond strength. The membrane and substrate can bond together more easily because they share a similar melting point since they are formed from or consist of the same material. This reduces and/or eliminates the need for a secondary material, such as a bonding agent or adhesive, to be used when bonding. Removing the need for a bonding agent/adhesive makes the textile easier to recycle.

The material of the substrate and the porous membrane may be hydrophobic.

Conventional WBTs require a water-repellent coating to be applied to an outer layer of material (e.g., the fabric substrate) to prevent it from becoming soaked during use. However, the water-repellent coating can be worn away by use and/or washing. When the water-repellent coating is damaged or removed, the fabric soaks up water which blocks the fabric's pores and prevents water vapour from being able to pass through, reducing breathability of the WBT.

Using a hydrophobic material for the substrate and the membrane of the textile may obviate the need for a water-repellent coating, further simplifying the construction of the textile.

The material may be or comprise a polymeric material. The polymeric material may be or comprise a fluorine-free polymeric material.

As conventional WBTs cannot be recycled, they are often burned or sent to landfill. Conventional WBT membranes are often manufactured using polymers containing fluorine which produce toxic gases when burned. For example, a Gore-Tex® membrane is manufactured from elongated polytetrafluoroethylene (e-PTFE). Similarly, water-repellent coatings applied to conventional WBTs are often made from toxic perfluorinated compounds (PFCs) such as perfluorinated sulfonic acids (PFOS), perfluorinated carboxylic acids (PFOA), fluorotelomer alcohols (FTOH), fluorocarbon polymers such as PTFE and fluorinated polymers.

Using a fluorine-free material for the membrane and the substrate of the textile may further reduce the environmental and/or health impact of recycling or disposing of the textile.

The polymeric material may be or comprise one or more of an α-polyolefin (such as polypropylene, polyethylene, polybutylene, polybutene etc.), a polyester, a nylon, or a thermoplastic polymer.

The polymeric material may be or comprise a thermoplastic polymer. That may enable easy processing of the material to form the substrate and the membrane. The thermoplastic polymeric material may be or comprise a thermoplastic polyolefin. Thermoplastic polyolefins typically have a low surface energy (e.g., similar to PTFE) which enables easy processing in addition to being water-repellent or hydrophobic.

The thermoplastic polyolefin may be or comprise polymethylpentene (PMP). PMP has a low surface energy and is strongly hydrophobic. That may enable the membrane to be water-impermeable, and prevent the substrate from becoming soaked (by repelling water). PMP is also inherently gas-permeable, even without pores. However, by forming a porous membrane from PMP, the gas-permeability of the material may be further enhanced without compromising water-impermeability.

The polymethylpentene polymer may be or comprise a 4-methyl-1-pentene polymer. The polymethylpentene polymer may be or comprise a copolymer of 4-methyl-1-pentene with one or more α-olefins. The one or more α-olefins may each have or comprise between 2 and 20 carbon atoms.

The polymeric material may be or comprise a protein based polymeric material. The polymeric material may be or comprise a polysaccharide polymeric material, such as cellulosic and chitosan polymeric material.

The polymeric material may be a non-thermoplastic polymer. The polymeric material may be a natural polymer.

The material may be or comprise a copolymer. The material may be or comprise a copolymer of PMP with one or more of polymethylpentane, polymethylhexane, polymethylheptane and polymethyloctane.

The material may comprise one or more additives. The material may comprise one or more of a zeolite, a pillared clay, an aluminophosphate and a silicophosphate.

The porous membrane may comprise a substantially continuous or monolithic membrane.

The porous membrane may be, or comprise, a film. The porous membrane may be, or comprise, a sheet.

The porous membrane may comprise a non-woven membrane. A non-woven membrane may allow the porous membrane to flex, stretch, compress or twist to follow movement of the substrate without becoming damaged. The non-woven membrane may comprise fibres. The fibres may be or comprise microfibres and/or nanofibres. A diameter of the fibres may be between substantially 50 nm and substantially 200 μm. A diameter of the fibres may be between substantially 50 nm and substantially 200 nm. Using fibres to provide a non-woven porous membrane may allow the porosity of the membrane to be easily controlled, for example, by selecting an appropriate fibre diameter and volumetric density of fibres in the membrane.

The non-woven porous membrane may comprise, or consist, of electro-spun fibres. The non-woven porous membrane may comprise, or consist, of melt-spun fibres. The non-woven membrane may be formed from, or comprise, a mesh or mesh-like structure of overlapping fibres.

A porosity of the porous membrane may be between substantially 10% and substantially 90% by volume. The porosity of the membrane may be between substantially 30% and substantially 90% by volume, or between substantially 60% and substantially 90% by volume.

A pore size of the porous membrane may be between substantially 0.001 μm and substantially 50 μm. The pore size of the porous membrane may be between substantially and substantially 30 μm, or optionally between substantially 0.04 μm and substantially 10 μm.

A porosity and/or pore size of the porous membrane may be selected depending on an intended use or application of the textile. For example, a textile for applications where waterproof properties are more important than breathability may have a lower porosity and/or a smaller pore size. In contrast, a textile for applications where breathability is more important than waterproof properties may have a higher porosity and/or a larger pore size. For applications where both good waterproof properties and good breathability is required, an intermediate porosity and/or pore size may be used.

The substrate may comprise a knitted substrate. The substrate may comprise a 3D knitted substrate.

Garments made from conventional WBTs require separate pieces of WBT material to be cut to shape and joined (e.g., sewn, stitched, glued) together. The seams where the separate pieces of material are joined must be separately waterproofed in an additional process in order to ensure the garment as a whole is waterproof. In addition, cutting pieces of WBT material to shape results in offcut waste which is typically burned or sent to landfill. The presence of seams in a garment may also restrict movement of the person wearing the garment, which can have a negative effect if, for example, the garment is being used during a sporting or recreational activity.

A 3D knitted substrate may be formed directly in the shape of a garment or product, rather than a flat knitted substrate. That may obviate the need for seams in the garment, which may further improve the waterproof properties of the textile or garment. In addition, a 3D knitted substrate may reduce or eliminate offcuts of the textile, further reducing the environmental impact of the textile. A lack of seams in the garment may also improve comfort and flexibility of the garment for a wearer, for example during sporting or recreational activity.

According to a second aspect, there is provided a garment or product comprising the textile of the first aspect. The garment or product may be a t-shirt, a jumper, a coat, trousers, shorts, a full-body suit such as a tracksuit, a pair of shoes, a bag, a hat, a pair of gloves, a scarf, and so on. The garment may comprise one or more additional material layers disposed on the substrate on the opposite side to the membrane. The additional material layer may provide comfort for the user.

According to a third aspect, there is provided a waterproof breathable garment. The garment may comprise a 3D knitted garment form. The garment may also comprise a porous membrane disposed on the 3D knitted garment form. The porous membrane may be a gas-permeable, water-impermeable porous membrane. The porous membrane and the 3D knitted garment form may be or comprise the same material.

According to a fourth aspect, there is provided a method of manufacturing a textile. The textile may be or comprise a waterproof breathable textile. The textile may be the textile of the first aspect. The method may comprise disposing a porous membrane on a substrate. The porous membrane may be a gas-permeable, water-impermeable porous membrane. The substrate and the porous membrane may be made from or comprise the same material.

Advantages of the method of the fourth aspect may be substantially the same or similar as those described above with respect to the textile of the first aspect.

The method may further comprise forming the porous membrane. Forming the porous membrane and disposing the porous membrane on the substrate may occur substantially simultaneously, or in (or as part of) a single processing step. That may further decrease the time, cost and energy expenditure of manufacturing the textile, further reducing the environmental impact of manufacturing the textile.

Forming the porous membrane may comprise forming a non-woven porous membrane. Forming the non-woven porous membrane may comprise depositing fibres of the material. Depositing fibres of the material may comprise depositing microfibres or nanofibres.

Forming the non-woven porous membrane may comprise electro-spinning fibres or melt-spinning fibres. That may result in the fibres forming a mesh or mesh-like structure of overlapping fibres to provide the porous membrane.

Forming the porous membrane may comprise using a template removal technique. Template removal may comprise mixing particles with a melted polymer, extruding the mixture as a film, then removing the particles to create pores.

An immiscible polymer material may be added to the film mixture. The immiscible polymer material may be removed afterwards to create pores. The immiscible material may act as a site where pores start to form as the membrane is stretched.

Forming the porous membrane may comprise a stretching technique. The stretching technique may comprise creating pores by heating an extruded film and then stretching the film to create physical pores.

Forming the porous membrane may comprise forming the porous membrane directly on the substrate. Forming the porous membrane directly on the substrate may comprise electro-spinning or melt-spinning fibres directly onto the substrate to form a non-woven porous membrane directly on the substrate. That may improve efficiency of manufacturing the textile. In addition, that may ensure that the porous membrane substantially conforms to the substrate to ensure optimal adhesion between the porous membrane and the substrate, compared to a porous membrane that is manufactured separately and subsequently disposed on the substrate. That may improve both performance and longevity of the textile.

The method may comprise bonding the porous membrane to the substrate. The bonding may comprise a mixture of mechanical bonding with chemical bonding and/or thermal bonding. The mechanical bonding may comprise ultrasonic bonding. The mechanical bonding may comprise stitching.

These bonding methods provide the advantage or reducing the amount of adhesive, which makes the final textile easier to recycle. The bonding methods may also reduce the amount of solvent used when forming the textile. By combining different bonding methods, the textile can be recyclable whilst maintaining sufficient bond strength.

The surfaces of the membrane and the substrate may be treated prior to bonding. The substrate and/or the membrane may be subject to surface modification techniques, such as plasma treatment.

The method may comprise knitting one or more threads of the material to form the substrate. The method may comprise weaving a plurality of threads of the material to form the substrate. Knitting or weaving threads of the material may be a simple, reliable approach for producing a substrate for a textile. Knitted or woven textiles are well-established and well-liked by consumers for their comfort and performance.

Knitting one or more threads may comprise 3D knitting the one or more threads to form the substrate. 3D knitting the one or more threads may comprise 3D knitting the one or more threads into the shape of a garment or product. Advantages of 3D knitting may be substantially the same or similar to those described above with respect to the textile of the first aspect.

The method may comprise forming one or more threads of the material. The method may comprise forming the one or more threads using melt-spinning. Melt-spinning may be a reliable approach for producing threads which have consistent dimensions and/or mechanical properties for being knitted or woven to form the substrate.

The method may comprise annealing the substrate and the porous membrane after disposing the porous membrane on the substrate. That may improve adhesion between the porous membrane and the substrate, which may in turn improve performance and longevity of the textile.

According a fifth aspect, there is provided a method of manufacturing a waterproof breathable garment. The method may comprise 3D knitting a garment form or garment shape. The method may further comprise disposing a porous membrane on the garment form or garment shape. The porous membrane may be a gas-permeable, water-impermeable porous membrane. The garment form or garment shape and the porous membrane may be made from the same material.

The terms “fibre”, “yarn”, and “thread” are used interchangeably throughout this application. The terms may be used to refer to the same feature. For example, a substrate described as being knitted from a “fibre” may equally be knitted from a “yarn” or “thread”.

Features which are described in the context of separate aspects and embodiments of the invention may be used together and/or be interchangeable wherever possible. Similarly, where features are described in the context of a single embodiment for brevity, those features may also be provided separately or in any suitable sub-combination. Features described in connection with the textile of the first aspect, the garment of the second aspect or the garment of the third aspect may have corresponding features definable with respect to the method of the fourth aspect or the method of the fifth aspect, and vice versa, and these embodiments are specifically envisaged.

### BRIEF DESCRIPTION OF THE DRAWINGS

Embodiments of the invention will now be described, by way of example only, with reference to the accompanying drawings, in which:

FIG. 1 shows an example of a conventional porous waterproof breathable membrane and illustrates how it operates;

FIG. 2 shows an embodiment of a waterproof breathable textile in accordance with the invention;

FIGS. 3A and 3B respectively show embodiments of a continuous porous membrane and a non-woven porous membrane in accordance with the invention;

FIGS. 4A and 4B respectively show embodiments of a knitted substrate and a woven substrate in accordance with the invention;

FIG. 4C shows a photograph of a substrate formed in accordance with the present invention;

FIG. 5 shows an embodiment of a method of manufacturing a waterproof breathable garment in accordance with the invention;

FIG. 6 shows an embodiment of a method of manufacturing a waterproof breathable textile in accordance with the invention;

FIGS. 7A and 7B shows examples of threads produced by melt-spinning a PMP copolymer;

FIG. 8 shows measured diameters of sample melt-spun PMP copolymer threads;

FIG. 9 shows stress-strain curves for three sample melt-spun PMP copolymer threads;

FIGS. 10A and 10B respectively show an electro-spun non-woven porous membrane of a PMP copolymer from different perspectives; and

FIG. 11 shows an image of membrane formed using solvent casting and template removal taken using a SEM.

Like reference numerals in different Figures may represent like elements.

### DETAILED DESCRIPTION

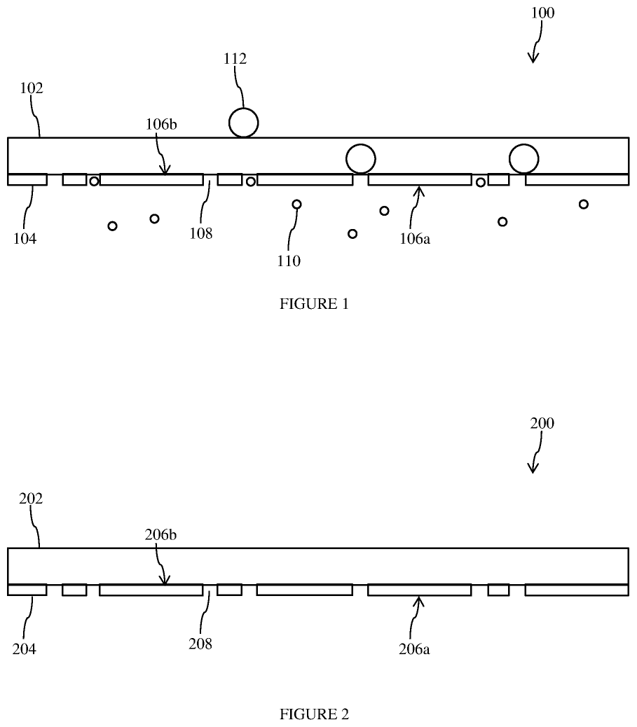

FIG. 1 shows an example of a conventional architecture of a waterproof breathable textile 100. The textile 100 comprises a fabric substrate 102 and a porous membrane 104 disposed on (for example, laminated to) the fabric substrate 102. The membrane 104 comprises a first surface 106a and a second surface 106b. The membrane 102 further comprises a plurality of pores 108. The pores 108 provide one or more channels or pathways between the first and second surfaces 106a, 106b of the membrane 104.

The pores 108 of the membrane 104 are depicted as separate, substantially linear channels in FIG. 1 for convenience. However, it will be appreciated that the pores 108 may provide a tortuous path through the membrane 104, and some of the pores 108 may be interconnected with one another.

The pores 108 typically have a size of several μm (e.g., between 1 μm and 10 μm). That size is significantly smaller than a diameter of a raindrop (typically ≥100 μm), but significantly larger than a water vapour molecule (around 40×10⁻⁶ μm). As such, the porous membrane 100 may allow water vapour molecules 110 (and other gases such as air) to permeate through the membrane 104 via the pores 108, whilst simultaneously preventing water droplets 112 from passing through the membrane 104. In addition to size, a surface tension of the water droplets 112 may be too great to allow the water droplets 112 to pass through the membrane 104. The porous membrane 104 is therefore gas-permeable but water-impermeable, making the textile 100 both waterproof and breathable. It will be appreciated that relative sizes of the pores 108, water vapour molecules 110 and water droplets 112 are not shown to scale in FIG. 1.

The waterproof breathable textile 100 may be formed into or integrated into a garment such as a raincoat. The fabric substrate 102 of the waterproof breathable textile 100 forms an exterior or outer surface of the garment. When the garment is worn in precipitation (e.g., rain, sleet, snow), the membrane 104 enables the wearer to remain warm and dry by preventing liquid water from passing through to an interior of the garment, as described above. However, the wearer may perspire whilst wearing the garment. Air on the interior of the garment (e.g., adjacent the first side 106a of the membrane 104) may therefore have a higher density or concentration of water vapour molecules 110 than air on an exterior side of the garment (e.g., adjacent the second side 106b of the membrane 104), providing a driving force for water vapour molecules 110 to diffuse to an exterior side of the garment. The membrane 104 allows perspiration produced by the wearer to be transported from an interior of the garment, through the pores 108 of the membrane 104, to an exterior of the garment, thereby keeping the user cool.

FIG. 2 shows an embodiment of a waterproof breathable textile 200 in accordance with the invention. The textile 200 comprises a similar structure or architecture to the textile 100 shown in FIG. 1. The textile 200 comprises a substrate 202 (e.g., a fabric substrate) and a porous membrane 204 disposed on the substrate 202. The membrane 204 comprises pores 208 connecting a first side of the membrane 206a to a second side of the membrane 208a. The pores 208 are shown schematically in FIG. 2 as linear channels between the first and second sides 206a, 206b of the membrane 204. However, it will be appreciated that the pores 208 may provide a tortuous path through the membrane 204, and some of the pores 208 may be interconnected with one another. The porous membrane 204 is therefore gas-permeable but water-impermeable, making the textile 200 both waterproof and breathable. In the embodiment shown, the substrate 202 and the porous membrane 204 are made from or comprise the same material or the same type of material.

The substrate 202 and the porous membrane 204 being made from or comprising the same material may enable the textile 200 to be easily recycled. Both layers 202, 204 of the textile 200 being made from or comprising the same material means that it may not be necessary to separate the substrate 202 from the membrane 204 in order to recycle the textile 200. The textile 200 can be recycled directly without any pre-processing (e.g., separation of layers 202, 204). In contrast, conventional WBTs are typically multi-layer, multi-material structures, in which a fabric substrate and a porous membrane are made from entirely different materials. However, the multi-layer structure of conventional WBTs makes it difficult to separate the different materials from one another in order to recycle the WBTs.

In the embodiment shown, the substrate 202 and the porous membrane 204 are made from or comprise a polymethylpentene (PMP) copolymer (e.g., TPX® MX004). PMP copolymer is a low surface energy thermoplastic polyolefin. PMP copolymer is strongly hydrophobic (highly water-repellent) and therefore the membrane 204 may be water-impermeable. The hydrophobic properties of PMP copolymer may allow the substrate 202 to repel water from an outer surface of the textile 200 (e.g., a surface of the substrate 202 opposite the membrane 204 when integrated into a garment), without requiring an additional hydrophobic coating to be applied to an outer surface of the textile 200. That may prevent the substrate 202 from becoming soaked or saturated with water. Typically, hydrophobic coatings comprise toxic perfluorinated compounds (PFCs) such as perfluorinated sulfonic acids (PFOS), perfluorinated carboxylic acids (PFOA), fluorotelomer alcohols (FTOH), fluorocarbon polymers such as PTFE and fluorinated polymers. PMP copolymer is a fluorine-free material and therefore not a PFC.

PMP copolymer is also inherently gas-permeable, whether or not there are pores present in the membrane 204 or not. In the embodiment shown, however, pores 208 are introduced into the membrane 204 to further enhance the gas-permeability (breathability) of the membrane 204. That is discussed in more detail below.

In some embodiments, the PMP copolymer comprises a copolymer of PMP with one or more other polymeric materials, for example polymethylpentane, polymethylhexane, polymethylheptane, polymethyloctane. Alternatively, the substrate 202 and the porous membrane 204 may be made from or comprise a different material. The material may be or comprise a different polymeric material (e.g., a single polymer or a copolymer), for example a thermoplastic polymeric material such as a thermoplastic polyolefin. Such a polymer material may comprise one or more of a zeolite, a pillared clay, an aluminophosphate and a silicophosphate (for example, as an additive). Alternatively, the material may be or comprise an inorganic material. Whether the material is a polymeric material or an inorganic material, the material may inherently comprise pores, or the material may be capable of being synthesised into a porous form to provide a porous membrane 204. The material may also be hydrophobic. Suitable hydrophobic polymeric materials include polyester (e.g., polyethylene terephthalate (PET)), polyolefin (e.g., polypropylene (PP), polyethylene (PE), thermoplastic polyolefin elastomer (POE), poly(ethylene-co-1-octene) (XLA) poly(ethylene-co-α-olefin)), polyamide, elastomeric polyamide, Nylon (e.g., Nylon 6, Nylon 6,6), polymeric organosilicon (e.g., polydimethylsiloxane (PDMS), poly-1-trimethylsilyl-1-propyne (PTP)), polyurethane (e.g., thermoplastic polyurethane (PU)), polycaprolactone (PCL), poly lactic acid (PLA), acrylonitrile butadiene styrene (ABS), polybutadiene (PB), polymethylmethacrylate (PMMA), polycarbonate (PC), polysulfone (PSU), polyimide (PI), polyvinylidene fluoride (PVDF), PTFE, and polystyrene (PS).

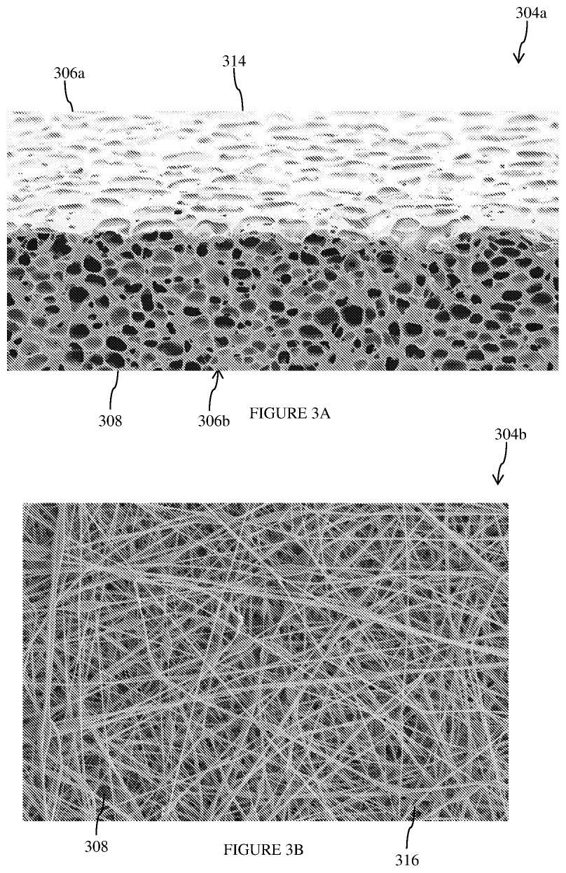

FIGS. 3A and 3B show embodiments of porous membranes 304 in accordance with the invention. The membranes 304 shown in FIGS. 3A and 3B can form part of a waterproof breathable textile in accordance with the invention, for example the textile 200 shown in FIG. 2.

FIG. 3A shows a porous membrane 304a. The membrane 304a comprises a substantially continuous or monolithic structure. In the embodiment shown, the substantially continuous structure of the membrane 304a comprises a substantially continuous or monolithic film or sheet 314 comprising pores 308. It will be appreciated that the membrane 304a may have an open-pore structure (e.g., similar to a sponge) providing channels between the first and second surfaces 306a, 306b of the membrane 304a.

FIG. 3B shows an alternative porous membrane 304b. The membrane 304b comprises a non-woven structure. In the embodiment shown, the non-woven structure of the membrane 304b comprises a plurality of fibres 316 (e.g., microfibres or nanofibres) of material. In the embodiment shown, the fibres 316 have a diameter of between substantially 50 nm and substantially 200 μm, but other fibre diameters and sizes may be used. The fibres 316 are overlaid on one another to provide a membrane 304b having a mesh or mesh-like structure. In the embodiment shown, the pores 308 in the membrane 304b comprise the spaces between the overlaid fibres 316, referred to herein as inter-fibre pores. Such an arrangement may provide a substantially open-pore structure providing channels between the first and second surfaces 306a, 306b of the membrane 304b. It will be appreciated that a pore size of the membrane 304b may be directly related to an areal or volumetric density of the fibres 316 in the membrane 304b. A higher density of the fibres 316 may result in a small average pore size. In some embodiments, the areal or volumetric density of the fibres may be between substantially 50% and substantially 70%. The fibres 316 may additionally be porous (e.g., the fibres 316 may comprise integral pores), referred to herein as intra-fibre pores. In the embodiment shown, the fibres 316 are randomly oriented with respect to one another to form the mesh. Alternatively, the fibres 316 may be overlaid on one another in an ordered arrangement to form the mesh structure of the membrane 304b.

In some embodiments, the porosity of the membrane 204, 304a, 304b is between 60% to 90%. Alternatively, the porosity may be between 10% to 90% or between 30% to 90%. The porosity may be selected depending on the performance requirements of the textile 200. It will be appreciated that a wide variety of techniques and/or approaches are available to those skilled in the art to control or modify porosity in various materials, either during manufacture or during post-processing.

In some embodiments, the size of each pore 208, 308 in the membrane 204, 204a, 204b is between substantially 0.04 μm and substantially 10.00 μm. Alternatively, the size of each pore may be between substantially 0.01 μm and substantially 30.00 μm or between substantially 0.001 μm and substantially 50.00 μm. It will be appreciated that a wide variety of techniques and/or approaches are available to those skilled in the art to control or modify pore size in various materials, either during manufacture or during post-processing.

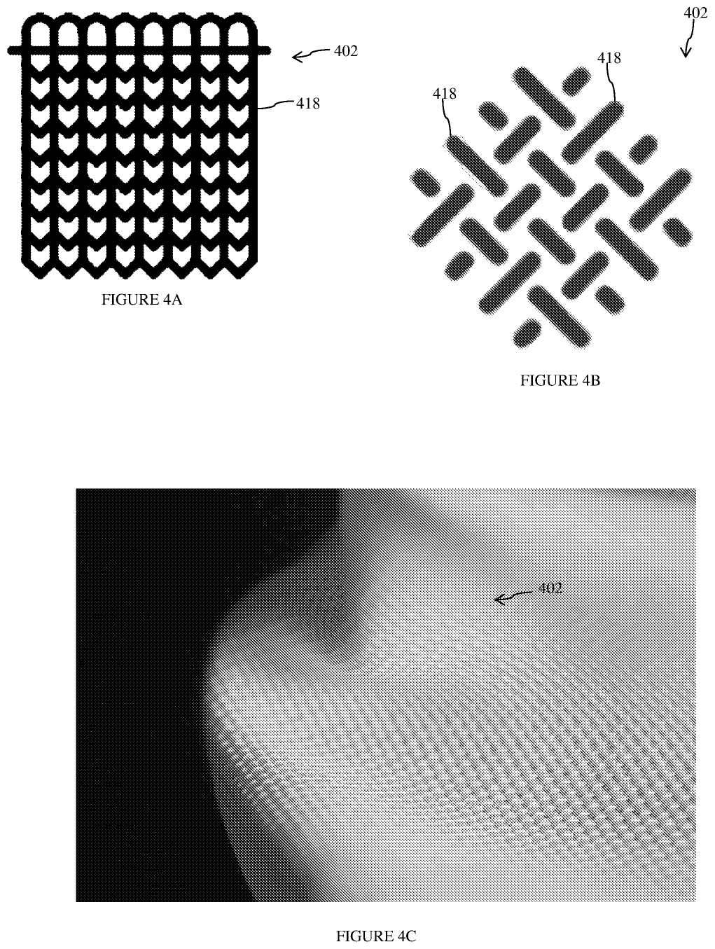

FIGS. 4A and 4B show embodiments of a substrates 402 in accordance with the invention. The substrates 402 shown in FIGS. 4A and 4B can form part of a waterproof breathable textile in accordance with the invention, for example the textile 200 shown in FIG. 2. FIG. 4C shows a photograph of a substrate 402 formed in accordance with the invention.

FIGS. 4A and 4B respectively show a knitted fabric substrate 402a and a woven fabric substrate 402b. The fabric substrates 402a, 402b are formed from one or more threads 418 of material such as PMP copolymer, as described above. PMP copolymer has a similar surface energy to PTFE but has a lower melting temperature. PMP copolymer may therefore be suitable for forming threads 418 (e.g., via fibre extrusion) for knitting or weaving a substrate 402a, 402b. Alternatively, the threads 418 may be formed from a different material, as described above.

In the embodiments shown, the thread(s) 418 has a diameter of between substantially and substantially 250 μm. Alternatively, the thread(s) 418 may have a larger or smaller diameter. A diameter of the thread(s) 418 may be selected depending on desired performance and/or properties (for example, flexibility, feel etc.) of the substrates 402a, 402b. A spacing between knitted loops in the knitted fabric substrate 402a, or between woven threads in the woven fabric substrate 402b, may be between substantially 0.1 μm and substantially 5 mm.

In the embodiment shown in FIG. 4A, the substrate 402a is a flat (substantially two-dimensional) knitted fabric. The thread 418 of material is knitted using a conventional knitting technique (e.g., using a knitting machine) to produce a flat knitted fabric substrate 402a. Alternatively, the substrate 402a may be a substantially three-dimensional knitted fabric. The knitted fabric may form or comprise a shape of at least part of a garment. The thread of material may be knitted using a three-dimensional (3D) knitting technique (e.g., using a digital knitting machine) to produce a substantially three-dimensional knitted fabric substrate 402. A three-dimensional knitted fabric substrate 402a may enable a single piece of material to be formed in the shape of a garment, onto which a porous membrane can be disposed. Typically, weatherproof garments are constructed by attaching a plurality of separate pieces of pre-formed WBT together. That creates offcut waste. In addition, in order to ensure such garments are fully waterproof, the seams at which the separate pieces of WBT are joined (e.g., sewn or stitched) to one another must also be separately waterproofed. That also increases the number of potential points through which the waterproofing of the garment may fail, decreasing reliability of the waterproof nature of the garment. In contrast, a three-dimensional knitted fabric substrate 402b may avoid the need to attach separate pieces of material together to form a garment. That may reduce offcut waste, reduce manufacturing expense and remove the presence of any seams in the garment, improving waterproof reliability of a waterproof, breathable garment.

In the embodiment shown in FIG. 4B, the substrate 402b is a woven fabric. The woven fabric substrate 402b comprises a plurality of threads 418 or yarns woven together. In the embodiment shown, the threads 418 are interwoven in a substantially ‘over-under’ arrangement. Alternatively, the substrate 402b may comprise a different weaving pattern. In the embodiment shown, the substrate 402b is a flat (substantially two-dimensional) woven fabric.

In one embodiment, the woven fabric substrate is woven as a plane weave using an 83 decitex yarn with a density of 104 gm⁻². The fabric sett may be 616.

In another embodiment, the woven fabric substrate is woven as a plane weave using a 150 decitex yarn with a density of 135 gm⁻². The fabric sett may be 360.

Alternatively, the substrate may be or comprise a different type of fabric such as a web of material, such as PMP copolymer or different material as described above.

FIG. 5 shows a method 500 of manufacturing a waterproof breathable textile 200 in accordance with the invention. The method 500 comprises disposing a gas-permeable, water-impermeable porous membrane 204 on a substrate 202. The substrate 202 and the porous membrane 204 are made from or comprise the same material 501. In the embodiment shown, the material 501 is a PMP copolymer as described above with respect to the textile 200. Alternatively, the material 501 may be a different material as described above with respect to the textile 200.

At step 520, the method 500 optionally comprises manufacturing or forming the substrate 202. Step 520a comprises forming one or more threads 418 of the material 501. In the embodiment shown, the one or more threads 418 of material 501 are formed using a melt-spinning process, but it will be appreciated that the threads 418 may be formed using a different process or technique. Preferably step 520a comprises forming one or more threads 418 having a diameter or thickness of between substantially 100 nm and substantially 500 μm, and more specifically between substantially 50 μm and substantially 250 μm, although the threads 418 may be formed having any suitable diameter. Step 520b comprises knitting a thread 418 of the material 501 to form a knitted fabric substrate. In the embodiment shown, the thread 418 of material 501 is three-dimensionally (3D) knitted (e.g., using a digital knitting machine) so that the substrate 202 is formed directly into the shape of a raincoat. It will be appreciated that the thread 418 may be 3D knitted into the shape of any garment or product such as a t-shirt, jumper, coat, trousers, shorts, full-body suits, shoes, bags, etc. Alternatively, a thread 418 of the material 501 may be knitted using a conventional knitting technique to form a substantially flat knitted fabric substrate, or a plurality of threads 418 of the material 501 may be woven to form a woven fabric substrate. Alternatively, a pre-manufactured substrate made from or comprising the material 501 may be used, and the method 500 may not comprise step 520.

At step 522, the method 500 optionally comprises forming fibres 316 of the material 501. In the embodiment shown, step 522 comprises forming the fibres 316 using an electro-spinning process. Alternatively, the fibres 316 may be formed using a different process or technique, for example a different melt-spinning process such as melt-blowing, dry-spinning, wet-spinning or dry-jet wet-spinning. Melt-blowing may be particularly suitable for forming fibres having diameters in the micrometre to sub-micrometre range. In the present disclosure, the term melt-spinning refers broadly to all fibre forming processes in which a material (e.g., a polymeric material) is melted and extruded through a nozzle to create a fibre. Some fibre forming processes (for example, electro-spinning and melt-blowing) may be used or controlled to form fibres containing integral pores (discussed further below). Preferably step 522 comprises forming fibres 316 having a diameter of between substantially 50 nm and substantially 200 nm, but fibres having different diameters and/or sizes may be formed. Alternatively, pre-manufactured fibres may be used.

At step 524, the method 500 comprises disposing a porous membrane 204 of the material 501 onto the formed substrate 202. Disposing the membrane 204 onto the substrate 202 results in the formation of a waterproof breathable textile 200. In the embodiment shown, disposing the membrane 204 onto the substrate 202 results in the formation of a waterproof breathable garment, because the substrate 202 is formed directly into the shape of a garment, as described above. If a substantially flat waterproof breathable textile 200 is formed, the textile 200 may require further processing (e.g., cutting, sewing, gluing) to form a garment from the textile 200.

In the embodiment shown, step 524 comprises disposing a non-woven porous membrane onto the substrate 202 by disposing the fibres 316 (e.g., microfibres or nanofibres) of the material 501 onto the substrate 202 to form a mesh or mesh-like structure, as described above. Depending upon the fibre forming process used, the fibres 316 may comprise integral pores, as described above. Disposing such fibres 316 onto the substrate 202 may provide a non-woven porous membrane comprising both pores 208 between the individual fibres 316 in the mesh structure (inter-fibre pores) and pores within the individual fibres 316 (intra-fibre pores).

In the embodiment shown, step 522 and step 524 of the method 500 take place substantially simultaneously. The fibres 316 are formed or fabricated (in the embodiment shown, electro-spun) directly onto the substrate 202. Fibres 316 are targeted directly onto the substrate 202 as part of the electro-spinning process. The formation of the fibres 316 and the deposition of the fibres 316 onto the substrate 202 to form a porous membrane 204 take place in a single processing step. It will be appreciated that the same approach may be employed for other fibre forming processes such as melt-blowing. Alternatively, step 522 and step 524 may be temporally separate from one another. For example, the fibres 316 may be formed prior to being deposited onto the substrate 202. The formed fibres 316 may be dispersed in a solvent and subsequently deposited onto the substrate 202 (e.g., sprayed, painted, dipped) to dispose the non-woven porous membrane onto the substrate 202. Alternatively, the fibres 316 may be deposited onto an intermediate or temporary substrate (for example, a metal or plastic sheet or surface) to form the porous membrane 204. The porous membrane 204 may then be transferred from the temporary substrate to the substrate 202 (e.g., removed from the temporary substrate and disposed on the substrate 202).

In some embodiments, the method 500 comprises annealing (e.g., heating) the manufactured textile 200. Annealing the textile 200 comprises annealing the textile 200 at a temperature similar or near to a melting point of the material, for example at a temperature that is between substantially ±50° C. of the melting point of the material. For example, a melting temperature of PMP copolymer is typically between substantially 220° C. and substantially 240° C. For a textile 200 manufactured from PMP copolymer, the method 500 may comprise annealing the textile 200 at a temperature between substantially 180° C. and substantially 260° C. For other polymeric materials, the annealing temperature should be based on the melting point of the material as described above, but an annealing temperature of between substantially 90° C. and 300° C., or between 150° C. and substantially 300° C. may be used, and preferably an annealing temperature of between substantially 180° C. and substantially 280° C. The annealing time may dependent upon the annealing temperature relative to the melting point of the material. For example, with respect to PMP copolymer, the annealing time may be on the scale of minutes (e.g., substantially 1 or more minutes) or hours (e.g., substantially 1 or more hours) for annealing temperatures lower than the melting point of PMP copolymer (e.g., below substantially 220° C.). Alternatively, the annealing time may be on the scale of milliseconds (e.g., substantially 1 or more milliseconds) or seconds (e.g., substantially 1 or more seconds) for annealing temperatures higher than the melting point of PMP copolymer (e.g., above substantially 220° C.). Annealing the textile 200 may improve adhesion between the substrate 202 and the porous membrane 204 by tacking or melting the substrate 202 and the porous membrane 204 together at one or more contact points between the two. Alternatively, the method 500 may not comprise annealing the manufactured textile 200. The substrate 202 and the porous membrane 204 are made of or comprise the same material 501. Intermolecular forces between the substrate 202 and the porous membrane 204 may therefore be sufficient to adhere the substrate 202 and the membrane 204 to one another. Alternatively, an adhesive or coupling agent may be applied to the substrate 202 before the non-woven porous membrane 204 is disposed on the substrate 202. Alternatively, the method 500 may comprise subjecting each of the substrate 202 and the porous membrane 204 to a solvent treatment to improve adhesion, or the method 500 may comprise bonding (e.g., ultrasonic bonding, pressure bonding) the substrate 202 and the porous membrane 204 together to improve adhesion.

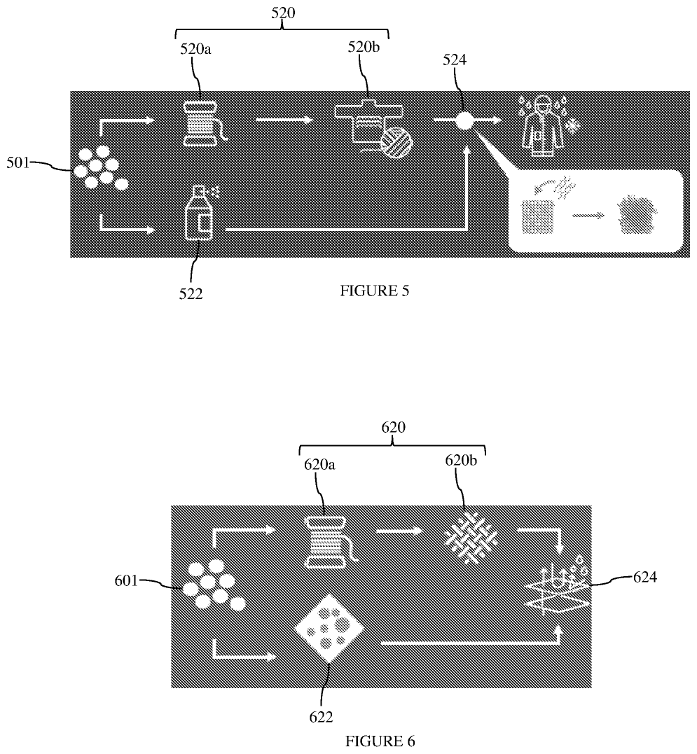

FIG. 6 shows a method 600 of manufacturing a waterproof breathable textile 200 in accordance with the invention. The method 600 comprises disposing a gas-permeable, water-impermeable porous membrane 204 on a substrate 202. The substrate 202 and the porous membrane 204 are made from or comprise the same material 601. In the embodiment shown, the material 601 is a PMP copolymer as described above with respect to the textile 200. Alternatively, the material 601 may be a different material as described above with respect to the textile 200.

At step 620, the method 600 optionally comprises manufacturing or forming the substrate 202. Step 620a comprises forming threads 418 of the material 601, substantially as described with respect to step 520a of the method 500. Step 620b comprises weaving threads 418 of the material 601 to form a woven fabric substrate.

Alternatively, a thread 418 of the material 601 may be knitted using a conventional knitting technique to form a substantially flat knitted fabric substrate, or a plurality of threads 418 of the material 601 may be woven to form a woven fabric substrate. Alternatively, a pre-manufactured substrate 202 made from or comprising the material 601 may be used, and the method 500 may not comprise step 620.

At step 622, the method 600 optionally comprises forming a porous membrane 204. Step 622 comprises forming a substantially continuous or monolithic porous membrane 204, such as a porous film or sheet 204 as described above. In the embodiment shown, step 622 comprises forming the porous membrane 204 using mechanical fibrillation. Alternatively, the porous membrane 204 may be formed using a different process or technique, such as thermocoagulation, wet coagulation, solvent extraction, template removal (e.g., dissolving or dispersing one component in a mixture to leave behind pores 208), foam coating, 3D printing, track etching, sintering, breath-figure self-assembly, injection moulding, precipitation (e.g., through crystallization), casting, extrusion or point bonding technology. In one embodiment, template removal is used where the templates are particle fillers or immiscible polymers. In one embodiment, the particle fillers are or comprise calcium carbonate.

At step 624, the method 600 comprises disposing a porous membrane 204 of the material 601 onto the formed substrate 202. Disposing the membrane 204 onto the substrate 202 results in the formation of a waterproof breathable textile 200. In the embodiment shown, the textile 200 is a substantially flat textile 200. The textile 200 may be used in its as fabricated form, or the textile 200 may be processed (e.g., cut, sewn, glued) to form a garment from the textile 200.

In the embodiment shown, step 624 comprises disposing overlaying the continuous porous membrane formed at step 622 (e.g., a porous film or sheet) onto the substrate 202. Step 622 and step 624 are therefore temporally separate, with step 624 occurring after step 622. Alternatively, step 622 and step 624 may take place substantially simultaneously, depending on the process or technique used to form the porous membrane 204. For example, the substrate 202 may be impregnated with a solution or melt of the material 601. The porous membrane 204 may then be substantially simultaneously formed and disposed on the substrate 202 via wet coagulation or thermocoagulation (e.g., using a bath). Alternatively, a solution of the material 601 may be sprayed or foamed onto the substrate 202, and the porous membrane 204 substantially simultaneously formed and disposed on the substrate 202 by wet coagulation or thermocoagulation.

In some embodiments, the method 600 comprises annealing (e.g., heating) the manufactured textile 200 as described above with respect to the method 500. Annealing the textile 200 may improve adhesion between the substrate 202 and the porous membrane 204. Alternatively, the method 500 may not comprise annealing the manufactured textile 200. The substrate 202 and the porous membrane 204 are made of or comprise the same material 601. Intermolecular forces between the substrate 202 and the porous membrane 204 may therefore be sufficient to adhere the substrate 202 and the membrane 204 to one another. Alternatively, an adhesive or coupling agent may be applied to the substrate 202 before the continuous porous membrane 204 is disposed on the substrate 202. Alternatively, the method 500 may comprise subjecting each of the substrate 202 and the porous membrane 204 to a solvent treatment to improve adhesion, or the method 500 may comprise bonding (e.g., ultrasonic bonding, pressure bonding) the substrate 202 and the porous membrane 204 together to improve adhesion.

Although the methods 500, 600 described above pertain to specific embodiments, it will be appreciated that any type of substrate 202 (e.g., knitted, 3D knitted, woven etc.) may be used in combination with any type of porous membrane (e.g., continuous, non-woven etc.) to form a textile 200.

The methods 500, 600 may optionally further comprise additional steps such as dying the textile 200, or integrating accessories (such as zips, buttons etc). into the textile 200 or a garment formed from the textile 200. In some embodiments, the integrated accessories are made from or comprise polymers from the same polymer family as those in the textile 200. In some embodiments, the integrated accessories are made from the same material as the textile 200.

### Specific Examples

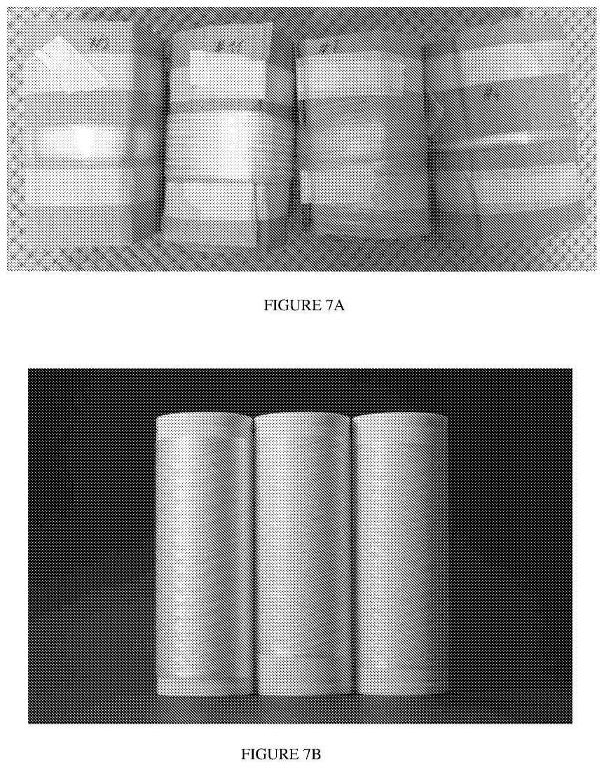

FIGS. 7A and 7B show examples of threads produced by melt-spinning a PMP copolymer (TPX® MX004). The melt-spinning of the threads was performed using a Collin E16T single-screw extruder, although other machines and/or manufacturing techniques may be used to produce the threads.

Sample threads were produced using thirteen different sets of parameters. The parameters used to produce each type of sample thread are displayed in Tables 1 and 2 below. Those parameters are merely examples, and it will be appreciated that other parameters (or sets of parameters) may be used to produce threads.

TABLE 1
Parameters used for manufacturing sample threads of PMP copolymer

| | Collin E16T Single-Screw Extruder | | | | | | | | | |
|---|---|---|---|---|---|---|---|---|---|---|
| Sample | T1 | T2 | T3 | T Adaptor | T die | Die | Screw | T melt | Current | P |
| Thread | (° C.) | (° C.) | (° C.) | (° C.) | (° C.) | filament | RPM | (° C.) | (%) | (bar) |
| 1 | 210 | 230 | 245 | 235 | 220 | mono | 2 | 230 | 51 | 84 |
| 2 | 210 | 230 | 245 | 235 | 220 | mono | 2 | 230 | 51 | 80 |
| 3 | 210 | 230 | 245 | 235 | 220 | mono | 2 | 229 | 51 | 80 |
| 4 | 210 | 230 | 245 | 235 | 220 | mono | 2 | 230 | 51 | 80 |
| 5 | 210 | 230 | 245 | 240 | 240 | mono | 1 | 230 | 51 | 60 |
| 6 | 210 | 230 | 245 | 240 | 240 | mono | 1 | 230 | 51 | 55 |
| 7 | 210 | 230 | 245 | 240 | 240 | mono | 1 | 230 | 51 | 54 |
| 8 | 220 | 240 | 255 | 260 | 260 | mono | 1 | 243 | 51 | 35 |
| 9 | 210 | 230 | 245 | 240 | 240 | mono | 1 | 230 | 51 | 65 |
| 10 | 210 | 230 | 245 | 240 | 240 | mono | 1 | 230 | 51 | 65 |
| 11 | 210 | 230 | 245 | 240 | 240 | mono | 1 | 230 | 51 | 65 |
| 12 | 210 | 230 | 245 | 240 | 240 | multi | 1 | 226 | 51 | 14 |
| 13 | 210 | 230 | 245 | 240 | 240 | multi | 1 | 235 | 51 | 6 |

TABLE 2
Parameters used for melt-spinning sample threads of PMP copolymer

| | Distance | | | | | | |
|---|---|---|---|---|---|---|---|
| | from die to | | | | | | |
| | collection roll | Water | Collection system | | | | |
| Sample | or water bath | bath? | | T roller | Roller | | |
| Thread | (cm) | (Yes/No) | Type | (° C.) | speed | Torque | Traverse |
| 1 | 10 | N | Chill rolls, unclamping | 235 | 220 | mono | 2 |
| 2 | 10 | N | Chill rolls, 100 μm gap | 235 | 220 | mono | 2 |
| 3 | 10 | N | Chill rolls, unclamping | 235 | 220 | mono | 2 |
| 4 | 10 | N | Chill rolls, <100 μm gap | 235 | 220 | mono | 2 |
| 5 | 10 | N | Chill rolls, 200 μm gap | 240 | 240 | mono | 1 |
| 6 | 20 | Y | Chill rolls, 100 μm gap | 240 | 240 | mono | 1 |
| 7 | 60 | Y | Chill rolls, unclamping | 240 | 240 | mono | 1 |
| 8 | 60 | Y | Chill rolls, unclamping | 260 | 260 | mono | 1 |
| 9 | 20 | Y | MDO collection unit, | 240 | 240 | mono | 1 |
| | | | clamping | | | | |
| 10 | 20 | Y | MDO collection unit, | 240 | 240 | mono | 1 |
| | | | clamping | | | | |
| 11 | 20 | Y | MDO collection unit, | 240 | 240 | mono | 1 |
| | | | clamping | | | | |
| 12 | 20 | Y | MDO collection unit, | 240 | 240 | multi | 1 |
| | | | clamping | | | | |
| 13 | 20 | Y | MDO collection unit, | 240 | 240 | multi | 1 |
| | | | clamping | | | | |

As shown in Table 2, different collection systems were used for the different sample threads. For example, for some samples a chill roll collection system was used, whereas for other samples an MDO (Machine Direction Orientation) collection unit was used. Further, some samples were collected and cooled using a water bath, whereas other samples were not. Thread samples 12 and 13 were made using multi-die filaments rather than mono-die filaments. The collection systems described are by way of example only, and alternative collection systems may be used when the thread 103 is being produced.

The parameters used to produce the sample threads were chosen to produce sample threads with particular or desired diameters and characteristics.

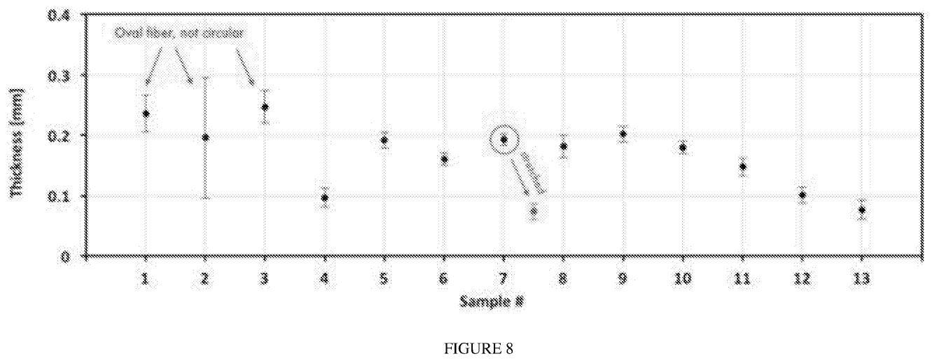

FIG. 8 shows measured thread diameters of the sample threads 1 to 13. The thickness of each sample thread was measured 10 times at randomly selected points along the length of the thread. The plot of FIG. 8 shows the mean thickness for each sample thread, together with error bars indicating the confidence intervals for the thickness measurements.

Sample threads 1, 2 and 3 were oval shaped rather than circularly shaped (having an oval-shaped cross-section rather than a circular cross-section), and so the confidence intervals for those sample threads are larger than those of sample threads having a circular cross-section. Sample thread 7 was stretched after it had been measured for a first time, and then measured for a second time subsequent to being stretched. The measurement for sample thread 7 taken after the thread was stretched is shown in FIG. 8 in between the points for sample threads 7 and 8. The diameter of sample thread 7 decreased after the thread was stretched. In order to consistently and reliably produce threads having a desired thickness, the threads could be manufactured to be thicker than desired and subsequently stretched.

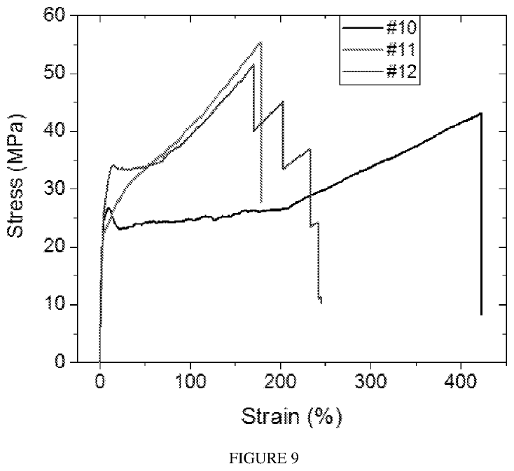

FIG. 9 shows stress-strain curves sample threads 10, 11 and 13. The following mechanical parameters were extracted from the stress-strain curves for each of the sample threads: Young's modulus, Yield stress, Yield strain, Strength, Strain at breaking point, Toughness, Yield force and Maximum force. The values for each of the measured parameters is shown in Table 3 below.

TABLE 3
Mechanical parameters measured for sample threads of PMP copolymer

| | Young's | Yield | Yield | | Strain | | Yield | Max |
|---|---|---|---|---|---|---|---|---|
| Sample | Modulus | Stress | strain | Strength | at break | Toughness | Force | force |
| Thread | (MPa) | (MPa) | (%) | (MPa) | (%) | (MPa) | (N) | (N) |
| 10 | 990 ± 110 | 24.1 ± 2.5 | 7.1 ± 1.3 | 40 ± 7 | 370 ± 70 | 103 ± 25 | 0.54 ± 0.1 | 0.91 ± 0.14 |
| 11 | 1190 ± 140 | 23.2 ± 2.1 | 4.4 ± 1.0 | 60 ± 6 | 181 ± 22 | 77 ± 11 | 0.29 ± 0.03 | 0.76 ± 0.09 |
| 13 | 1080 ± 110 | 26 ± 3 | 5.8 ± 0.9 | 53 ± 10 | 220 ± 80 | 80 ± 30 | 0.75 ± 0.12 | 1.53 ± 0.15 |

The tests were performed using an Instron 5967 universal testing machine equipped with a 100N load cell. The strain was measured using grip-to-grip separation. Five specimens were tested for each sample using a test speed of 100 mm/min (i.e. 100%/min strain rate) after a preload of 0.05N. The Young's modulus was calculated over a strain range of 0.1% to 0.5%. The yield point was located where the slope of the stress-strain curve was 20% of the Young's modulus. The “yield force” and “strength (max) force” were also recorded to directly compare the actual forces needed to permanently deform and break the thread samples. The toughness (i.e. the energy used to break a sample) was calculated as the area under the stress-strain curve.

The measured characteristics of the sample threads indicate that melt-spun threads are suitable for use during process such as knitting, 3D knitting, weaving to form substrates for waterproof breathable textiles such as the textile 200 described above. The measured characteristics of the sample threads also indicated that such threads are suitable for forming waterproof breathable garments and other waterproof breathable products, because the threads will be able to withstand external forces and resist damage. The parameters used to produce the sample threads may be altered to produce a fibre having a tensile strength of up to substantially 5 GPa, or to tune the strain at break of the fibre to be between substantially 10% and substantially 500%. For example, the temperature and speed of collection (e.g., using a collection roller) may be altered to adjust the mechanical properties of the fibres. To increase or maximise fibre tensile strength, a collection speed (e.g., a roller speed) may be maximised (without resulting in fibre fracture), whilst a collection temperature (e.g., a roller temperature) may be minimised (for example, substantially 30° C. or lower). That may increase a crystallinity of the fibre in an axial direction (e.g., along a length of the fibre) which in turn may increase a tensile strength of the fibre. Conversely, to maximise a strain at break of the fibre, the opposite parameters may be used—a collection speed (e.g., a roller speed) may be minimised, whilst a collection temperature (e.g., a roller temperature) may be maximised (for example, substantially 100° C. or higher). That may increase a proportion of amorphous region in the fibre which in turn may increase a strain at break of the fibre. It will be appreciated that a collection speed may be specific to a geometry and type of collection system used, for example a chill roll collection system or a MDO collection unit.

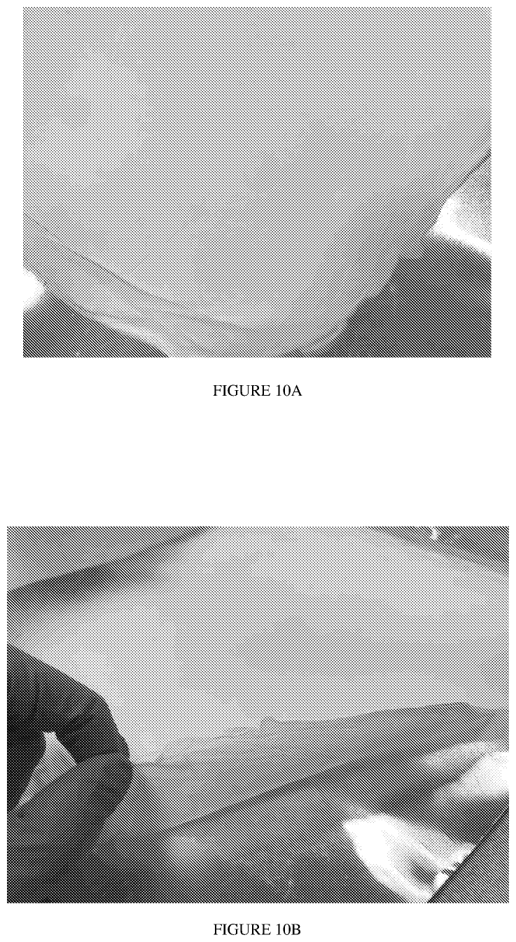

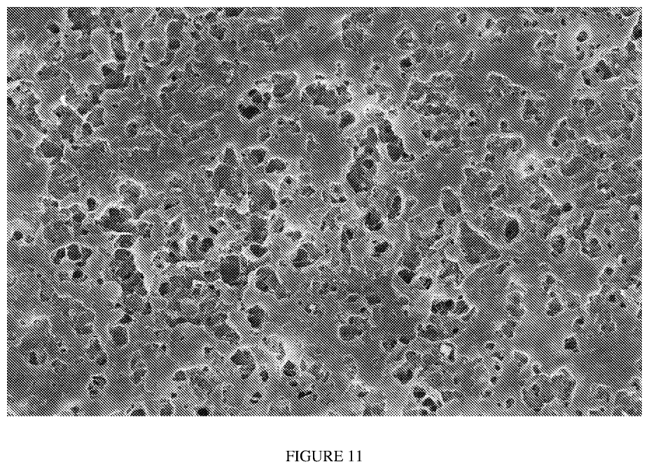

FIGS. 10A and 10B show an example of a non-woven porous membrane from different perspectives.

The non-woven porous membrane shown in FIGS. 10A and 10B is made from microfibres of PMP copolymer (TPX® MX004) that were electro-spun directly onto a metal sheet. FIGS. 10A and 10B illustrate that a non-woven porous membrane may be fabricated directly (using electro-spinning, melt-spinning etc.) onto a substrate, for example a substrate 202 as described above with respect to the textile 200.

The electro-spinning parameters used to produce the non-woven porous membrane shown in FIGS. 10A and 10B are shown in Table 4 below. Nine sample non-woven porous membranes were fabricated, each with a different set of parameters. Those parameters are merely examples, and it will be appreciated that other parameters (or sets of parameters) may be used to produce a non-woven porous membrane.

TABLE 4
Parameters used for electro-spinning sample
porous membranes of PMP copolymer

| Sample ID | CB12 | CB10 | CB22 | CB14 | CB15 | CB16 | CB19 | CB20 | CB21 |
|---|---|---|---|---|---|---|---|---|---|
| PMP conc. | 6 | | | 3 | | | 2 | | |
| (% w/w) | | | | | | | | | |
| Rate | 6 | 6 | 8 | 5 | 8 | 8 | 7 | 8 | 8 |
| (mL/h) | | | | | | | | | |
| Distance | 15 | 15 | 14 | 15 | 14 | 14 | 14 | 15 | 14 |
| (cm) | | | | | | | | | |
| Voltage | 18 | 18 | 17 | 16.5 | 17 | 17 | 17 | 17 | 17 |
| (kV) | | | | | | | | | |
| Volume | 9 | 10 | 8 | 5 | 7 | 9 | 9.5 | 10.5 | 11.5 |
| (mL) | | | | | | | | | |
| Temp. | 22.9 | 21.1 | 20.8 | 22.9 | 19.7 | 19.1 | 22.8 | 22.5 | 22.5 |
| (° C.) | | | | | | | | | |
| Humidity | 63 | 73 | 69 | 63 | 60 | 63 | 70 | 68 | 69 |
| (%) | | | | | | | | | |
| Membrane | 40-60 | 40-90 | 30-50 | 40-50 | 30-40 | 20-55 | 40-70 | 50-60 | 40-65 |
| thickness | | | | | | | | | |
| (μm) | | | | | | | | | |

Solvent casting and template removal was used to produce 4 membranes. The template used was Polcarb 90S surface treated calcium carbonate filler from Imerys S. A.
Membrane 1 was formed using a polypropylene-polymethylpentene copolymer (PP-co-PMP) with 70 wt % filler.
Membrane 2 was formed using a 1:1 mixture of polymethylpentene with polypropylene-polymethylpentene copolymer (PP-co-PMP) with 60 wt % filler.
Membrane 3 was formed using a 1:2 mixture of polymethylpentene with polypropylene-polymethylpentene copolymer (PP-co-PMP) with 60 wt % filler.
Membrane 4 was formed using a mixture of polymethylpentene with polybutene with 70 wt % filler.

The membranes were strength tested. The results of the tests are shown in table 5 below.

TABLE 5
Strength test results for membranes formed
using solvent casting and template removal.

| | Max | Max | Yield | Stress at | | Work | Elastic |
|---|---|---|---|---|---|---|---|
| | Force | displacement | stress | Fracture | Elongation | Done | Modulus |
| Sample | (N) | (mm) | (MPa) | (MPa) | (%) | (mJ) | (MPa) |
| Membrane | 2.75 ± | 163.3 ± | 0.31 ± | 4.19 ± | 327 ± | 201 ± | 33 ± |
| 1 | 0.16 | 4.1 | 0.07 | 0.14 | 8 | 10 | 11 |
| Membrane | 2.91 ± | 101.0 ± | 2.87 ± | 3.97 ± | 202 ± | 252 ± | 127 ± |
| 2 | 0.12 | 28.8 | 0.06 | 0.38 | 28 | 57 | 10 |
| Membrane | 2.94 ± | 112.9 ± | 1.87 ± | 4.30 ± | 226 ± | 238 ± | 112 ± |
| 3 | 0.61 | 22.9 | 0.05 | 0.83 | 30 | 61 | 10 |
| Membrane | 3.08 ± | 162.4 ± | 1.4 ± | 4.46 ± | 325 ± | 336 ± | 135 ± |
| 4 | 0.16 | 9.3 | 0.1 | 0.05 | 19 | 9 | 10 |

The tests were performed using an Mecmesin of MultiTest 2.5i Test System equipped with a 250 N load cell. The strain was measured using grip-to-grip separation where the initial gauge length was 50 mm and sample width was 10 mm. Three specimens for each membrane composition were tested for each sample using a test speed of 25 mm/min (i.e. 50%/min strain rate) after a preload of 0.05 N. The Elastic modulus was calculated over a strain range of 0.1% to 0.5%. The yield point was located where the slope of the stress-strain curve was 20% of the Young's modulus. The “yield force” and “strength (max) force” were also recorded to directly compare the actual forces needed to permanently deform and break the membrane samples. The work done relates to the material toughness (i.e. the energy used to break a sample) and was calculated as the area under the stress-strain curve.

FIG. 11 shows an image taken of Membrane 1 using a SEM.

From reading the present disclosure, other variations and modifications will be apparent to the skilled person. Such variations and modifications may involve equivalent and other features which are already known in the art of textiles, in particular waterproof breathable textiles, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness, it is also stated that the term “comprising” does not exclude other elements or steps, the term “a” or “an” does not exclude a plurality, and any reference signs in the claims shall not be construed as limiting the scope of the claims.

1. A waterproof breathable textile comprising:
a substrate; and
a gas-permeable, water-impermeable porous membrane disposed on the substrate;
wherein the substrate and the porous membrane are made from or comprise the same material or the same type of material.

2. (canceled)

3. The textile of claim 1, wherein the material is or comprises a polymeric material; and/or wherein the substrate and the porous membrane are made from or comprise one or more polymers from within the same polymer category, optionally, wherein the polymer category is polyolefins, polyesters, or polyamides.

4. (canceled)

5. The textile of claim 1, wherein the material is hydrophobic.

6. The textile of claim 3 wherein the polymeric material is or comprises a fluorine-free polymeric material.

7. The textile of claim 3 wherein the polymeric material is or comprises a thermoplastic polymer, optionally, wherein the thermoplastic polymeric material is or comprises a thermoplastic polyolefin, and further optionally, wherein the thermoplastic polyolefin comprises polymethylpentene.

8. (canceled)

9. (canceled)

10. The textile of claim 3 wherein the polymeric material is or comprises a copolymer, optionally wherein the polymeric material is or comprises a copolymer of polymethylpentene with one or more of polymethylpentane, polymethylhexane, polymethylheptanem polymethyloctane, one or more α-olefins, or one or more α-polyolefins.

11. (canceled)

12. The textile of claim 1, wherein the material comprises one or more of a zeolite, a pillared clay, an aluminophosphate and a silicophosphate.

13. The textile of claim 1, wherein the porous membrane comprises:
i) a substantially continuous or monolithic membrane; or
ii) a non-woven membrane, and optionally wherein the non-woven membrane comprises fibres, and optionally comprises microfibres or nanofibers, and further optionally, wherein the fibres comprise a diameter of between substantially 50 nm and substantially 200 μm or between substantially 50 nm and substantially 200 nm.

14. (canceled)

15. (canceled)

16. The textile of claim 1, wherein:
i) a porosity of the porous membrane is between substantially 10% and substantially 90% by volume, and optionally between substantially 30% and substantially 90% by volume, and further optionally between substantially 60% and substantially 90% by volume; and/or
ii) a pore size of the porous membrane is between substantially 0.001 μm and substantially 50 μm, and optionally between substantially 0.01 μm and substantially 30 μm, and further optionally between substantially 0.04 μm and substantially 10 μm.

17. The textile of claim 1, wherein the substrate comprises:
i) a knitted substrate, and optionally comprises a 3D knitted substrate; or
ii) a woven substrate.

18. A garment or product comprising the textile of claim 1.

19. The method of claim 30, further comprising forming the porous membrane.

20. The method of claim 19, wherein forming the porous membrane and disposing the porous membrane on the substrate are performed substantially simultaneously or in a single processing step.

21. The method of claim 19, wherein forming the porous membrane comprises forming a non-woven porous membrane, and optionally wherein forming the non-woven porous membrane comprises depositing fibres of the material, and optionally comprises depositing microfibres or nanofibers, and optionally, wherein forming the non-woven porous membrane comprises electro-spinning fibres or melt-spinning fibres.

22. (canceled)

23. (canceled)

24. The method of claim 19, wherein forming the porous membrane comprises forming the porous membrane directly on the substrate.

25. The method of claim 30, further comprising:
i) knitting one or more threads of the material to form the substrate; or
ii) weaving a plurality of threads of the material to form the substrate.

26. The method of claim 25, further comprising forming one or more threads of the material, and optionally forming the one or more threads using melt-spinning.

27. The method of claim 25, part i), wherein knitting the one or more threads comprises 3D knitting the one or more threads to form the substrate, optionally, wherein 3D knitting the one or more threads comprises 3D knitting the one or more threads to form the substrate in the shape of a garment or product, and optionally wherein the garment is a raincoat.

28. (canceled)

29. The method of claim 30, further comprising annealing the substrate and the porous membrane after disposing the porous membrane on the substrate.

30. A method of manufacturing a waterproof breathable textile, the method comprising:
disposing a gas-permeable, water-impermeable porous membrane on a substrate;
wherein the substrate and the porous membrane are made from or comprise the same material or the same type of material.
